(19) United States
(12) Patent Application Publication
(10) Pub. No.: US 2017/0355228 A1
(43) Pub. Date: Dec. 14, 2017

(54) Pneumatic Tire

(71) Applicant: The Yokohama Rubber Co., Ltd., Minato-ku, Tokyo (JP)

(72) Inventor: Shota Sakairi, Hiratsuka-shi, Kanagawa (JP)

(21) Appl. No.: 15/521,241

(22) PCT Filed: Oct. 15, 2015
(86) PCT No.: PCT/JP2015/079143

§ 371 Date: Apr. 21, 2017

(30) Foreign Application Priority Data
Oct. 22, 2014 (JP) 2014-215217

(51) Int. Cl. B60C 5/14; B29D 30/42; B29D 30/06

(52) U.S. Cl. CPC B60C 5/14; B29D 30/0681; B29D 30/42; B29D 2030/423; B60C 2005/145; B29D 2030/0682

(57) ABSTRACT

A pneumatic tire including an innerliner member applied on a tire inner circumferential surface, the innerliner member being constituted from an at least three-layer structure including a film having a main component of a thermoplastic resin or a thermoplastic elastomer containing a blend of a thermoplastic resin and an elastomer, and rubber sheets layered on both sides of the film; and a lap splice portion in which tire circumferential direction end portions of the film are overlapped with the rubber sheets inbetween. The rubber sheet on the tire cavity side of the innerliner member disposed on the tire cavity side in the lap splice portion is formed longer along the tire circumferential length than the film adjacent thereto.

### TECHNICAL FIELD

The present technology relates to a pneumatic tire.

More particularly, the present technology relates to a pneumatic tire having an innerliner member applied on a tire inner circumferential surface, the innerliner member constituted from an at least three-layer structure including a film having a main component of a thermoplastic resin or a thermoplastic elastomer composition containing a blend of a thermoplastic resin and an elastomer, and rubber sheets layered on both sides of the film, the tire comprising a lap splice structure in which tire circumferential direction end portions of the film are overlapped with each other with the rubber sheets inbetween; wherein tire failure does not occur, such as the bonding condition of the lap splice portion loosening due to delamination and the bond portion opening when the tire is inflated during vulcanization molding, or, as a result thereof, cracking occurring in the vicinity of the lap splice portion after the pneumatic tire starts to travel, and wherein this portion has excellent durability.

### BACKGROUND ART

Various studies have recently been conducted due to the fact that both a reduction in total tire weight and high air permeation preventive properties can be achieved by using a film having a main component of a thermoplastic resin or a thermoplastic elastomer composition containing a blend of a thermoplastic resin and an elastomer as an innerliner member (see, e.g., Japanese Unexamined Patent Application Publication No. H8-217923A and International Patent Application Publication Nos. WO/2008/53747 and WO/2012/086276).

For example, studies have been conducted on the use of a tire in which an innerliner member constituted from an at least three-layer structure including a film having a main component of a thermoplastic resin or a thermoplastic elastomer composition containing a blend of a thermoplastic resin and an elastomer, and rubber sheets layered on both sides of the film, is applied on the tire inner circumferential surface. To use an innerliner member of this type as a tire structural member, a production method is employed wherein the innerliner member is wrapped around a tire molding drum, the end portions are lap spliced, and the tire undergoes a vulcanization step (see, e.g., Japanese Unexamined Patent Application Publication Nos. 2006-198848A, 2012-6499A, and 2012-56454A).

Specifically, there is a technique in which an innerliner member having such a layered structure is wrapped around a tire molding drum so as to have a cylindrical shape, and at that time the two circumferential direction end portions are lap spliced to each other and the tire undergoes a vulcanization molding step to produce a pneumatic tire having a lap spliced innerliner layer.

When such a technique is used, it is preferable to use an innerliner member configured from an at least three-layer structure including a film and rubber sheets layered on both sides of the film, because the rubber sheets are overlapped and lap spliced to each other and splicing can be securely performed.

However, during the process from during vulcanization molding to immediately after molding, separation occurs at the interfaces of the film and rubber sheets, and further, the bond portion (splice portion) opens, which is thought to be caused by that separation.

To describe this through drawings, as illustrated in FIG. 5A, an innerliner member 1 constituted of an at least three-layer structure including a film 2, having a main component of a thermoplastic resin or a thermoplastic elastomer composition containing a blend of a thermoplastic resin and an elastomer, and rubber sheets 3A, 3B layered on both sides of the film 2 is formed into a required size (length) determined according to tire size, and a lap splice portion 4 is provided on both end portions thereof on a tire molding drum 5 illustrated schematically by double-dotted lines. The rubber sheet 3B functions as tie rubber having a function of bonding with other tire components such as the carcass layer.

As illustrated in FIG. 5B, during the process from during vulcanization molding to immediately after molding with a bladder, a separation condition 6 occurs at the interface between the film 2 and rubber sheet 3A, particularly at the interface in the vicinity of the end portion, and further, due to that separation, opening of the lap splice portion 4 progresses. In particular, in the case of the innerliner member 1 having an at least three-layer structure described above, the interface between the film 2 and rubber sheet 3A, particularly the interface in the vicinity of the end portion, tends to become an origin of the separation condition 6 in the molding process because the adhesion bonding force (tack) between the surface of the molding drum 5 and the rubber sheet 3A is high.

As illustrated in the schematic diagram of FIG. 5C, after vulcanization molding, the innerliner member itself constitutes an innerliner layer 10, and in the vicinity of the lap splice portion 4, the end portions of the film 2 overlap each other with the rubber sheets 3A, 3B inbetween, forming the lap splice portion 4. In FIG. 5C, the top is the tire outer circumference side, and the bottom is the tire cavity side. Furthermore, the X-X direction is the tire circumferential direction. In the tire as a whole, there is a lap splice portion 4 where the tire circumferential direction ends of the innerliner member 1 overlap across the tire width direction, and a pneumatic tire T in which the lap splice portion 4 is present across the tire width direction E-E is formed (FIG. 4).

The problems that a separation condition occurs at the interface between the film 2 and rubber sheet 3A, particularly at the interface in the vicinity of the end portions, and further, that opening of the lap splice portion 4 progresses due to that separation, are problems that occur in the tire vulcanization molding step, and are also thought to be problems that should be considered after the pneumatic tire starts to travel. In FIG. 5C, the vicinity of the ends of the film 2 indicated by reference sign 7 are the locations where this phenomenon should be considered.

### SUMMARY

The present technology provides a pneumatic tire including an innerliner member applied on a tire inner circumferential surface, the innerliner member being constituted from an at least three-layer structure including a film having a main component of a thermoplastic resin or a thermoplastic elastomer composition containing a blend of a thermoplastic resin and an elastomer, and rubber sheets layered on both sides of the film, the tire comprising a lap splice structure in which tire circumferential direction end portions of the film are overlapped with each other with the rubber sheets inbetween; wherein tire failure does not occur, such as the bonding condition of the lap splice portion loosening due to delamination and the bond portion opening when the tire is inflated during vulcanization molding, or, as a result thereof, cracking occurring in the vicinity of the lap splice portion after the pneumatic tire starts to travel, and wherein this portion has excellent durability.

A pneumatic tire of the present technology has configuration (1) below.

(1) A pneumatic tire having an innerliner member 1 applied on a tire inner circumferential surface, the innerliner member 1 constituted from an at least three-layer structure including a film 2 having a main component of a thermoplastic resin or a thermoplastic elastomer composition containing a blend of a thermoplastic resin and an elastomer, and rubber sheets 3A, 3B layered on both sides of the film 2; and a lap splice portion 4 in which tire circumferential direction end portions of the film 2 are overlapped with the rubber sheets 3A, 3B inbetween; wherein the rubber sheet 3A on a tire cavity side of the innerliner member 1 disposed on the tire cavity side in the lap splice portion 4 is formed longer along the tire circumferential length than the film 2 adjacent thereto.

The pneumatic tire of the present technology according to the above is preferably configured as described in any of (2) to (7) below.

(2) The pneumatic tire according to the above (1), wherein a length (G) for which the rubber sheet 3A on the tire cavity side of the innerliner member 1 disposed on the tire cavity side in the lap splice portion 4 is formed longer along the tire circumferential length than the adjacent film 21 is not less than 3 mm.

(3) The pneumatic tire according to the above (1) or (2), wherein a length (B) for which the rubber sheet 3B on the tire outer circumference side of the innerliner member 1 disposed on the tire cavity side in the lap splice portion 4 is formed longer along the tire circumferential length than the adjacent film 21 is not less than 3 mm.

(4) The pneumatic tire according to any one of the above (1) to (3), wherein a lap slice length (S) between the innerliner member 1 disposed on the tire outer circumference side and the innerliner member 1 disposed on the tire cavity side in the lap splice portion 4 is not less than 3 mm and not greater than 25 mm.

(5) The pneumatic tire according to any one of the above (1) to (4), wherein a lap slice length (A) between a film 22 of the innerliner member 1 disposed on the tire outer circumference side and a film 21 of the innerliner member 1 disposed on the tire cavity side in the lap splice portion 4 is not less than 0 mm.

(6) The pneumatic tire according to any one of the above (1) to (5), wherein the rubber sheet 3B on the tire outer circumference side and the rubber sheet 3A on the tire cavity side of the innerliner member 1 disposed on the tire cavity side in the lap splice portion 4 have a length difference (C), and the rubber sheet 3A on the tire cavity side is not less than 3 mm longer.

(7) The pneumatic tire according to any one of the above (1) to (5), wherein the rubber sheet 3B on the tire outer circumference side and the rubber sheet 3A on the tire cavity side of the innerliner member 1 disposed on the tire cavity side in the lap splice portion 4 have a length difference (C), and the rubber sheet 3B on the tire outer circumference side is not less than 3 mm longer.

The present technology according to configuration (1) provides a pneumatic tire including an innerliner member applied on a tire inner circumferential surface, the innerliner member being constituted from an at least three-layer structure including a film having a main component of a thermoplastic resin or a thermoplastic elastomer composition containing a blend of a thermoplastic resin and an elastomer, and rubber sheets layered on both sides of the film; and a lap splice structure in which tire circumferential direction end portions of the film are overlapped with each other with the rubber sheets inbetween; wherein tire failure does not occur, such as the bonding condition of the lap splice portion loosening due to delamination and the bond portion opening when the tire is inflated during vulcanization molding, or, as a result thereof, cracking occurring in the vicinity of the lap splice portion after the pneumatic tire starts to travel, and wherein the splice portion of the innerliner member has excellent durability.

The pneumatic tires of the technologys according to any one of configurations (2) to (7) provide pneumatic tires capable of obtaining more reliable and greater effects than those obtained by the pneumatic tire of the present technology according to configuration (1).

### BRIEF DESCRIPTION OF DRAWINGS

FIG. 1 is a diagram for explaining an embodiment of the pneumatic tire according to the present technology. It is a side view for schematically explaining an example of a splice portion structure prior to vulcanization molding.

FIG. 2 is a diagram for explaining another embodiment of the pneumatic tire according to the present technology. It is a side view for schematically explaining an example of a splice portion structure prior to vulcanization molding.

FIG. 3 is a diagram for explaining another embodiment of the pneumatic tire according to the present technology. It is a side view for schematically explaining an example of a splice portion structure prior to vulcanization molding.

FIG. 4 is a partially fractured perspective view illustrating an example of an embodiment of the pneumatic tire according to the present technology. It explains the positional relationship of the lap splice portion within the tire when the innerliner member according to the present technology is used.

FIGS. 5A, 5B, and 5C are diagrams for explaining problems of conventional art. FIG. 5A illustrates a state in which an innerliner member having a predetermined size (length) is formed in an overlapping manner into an annular shape on a tire molding drum with a lap splice portion 4 provided on both end portions thereof. FIG. 5B schematically illustrates a state in which separation has occurred between the film and the rubber sheet during vulcanization molding of the tire in the state shown in FIG. 5A. FIG. 5C is a side view for schematically explaining an example of a splice portion structure after vulcanization molding.

### DETAILED DESCRIPTION

A detailed explanation of the pneumatic tire of the present technology will be given below while referencing the drawings.

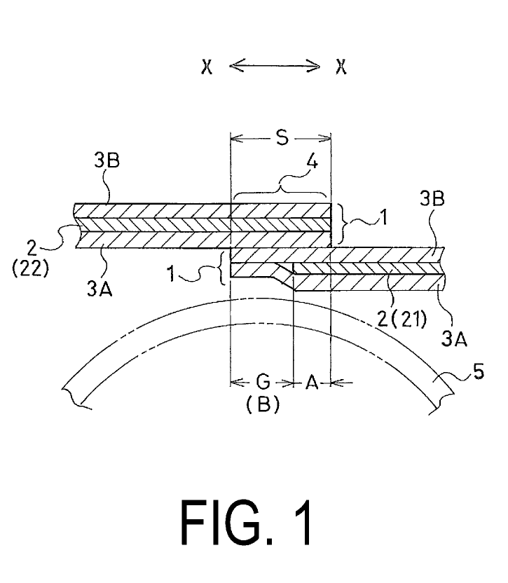

As illustrated in FIG. 1, the pneumatic tire of the present technology is a pneumatic tire having an innerliner member 1 applied on a tire inner circumferential surface, the innerliner member 1 constituted from an at least three-layer structure including a film 2 having a main component of a thermoplastic resin or a thermoplastic elastomer composition containing a blend of a thermoplastic resin and an elastomer, and rubber sheets 3A, 3B layered on both sides of the film 2, the tire comprising a lap splice structure in which tire circumferential direction end portions of the film 2 are overlapped with the rubber sheets 3A, 3B inbetween. The rubber sheet 3A on a tire cavity side of the innerliner member 1 disposed on the tire cavity side in the lap splice portion 4 is formed longer along the tire circumferential length than an adjacent film 2.

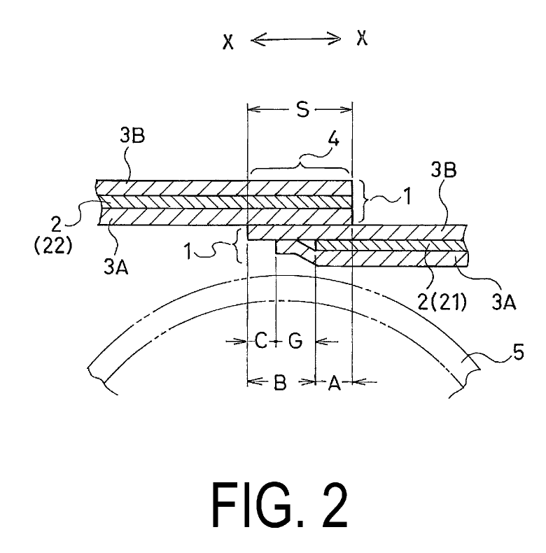

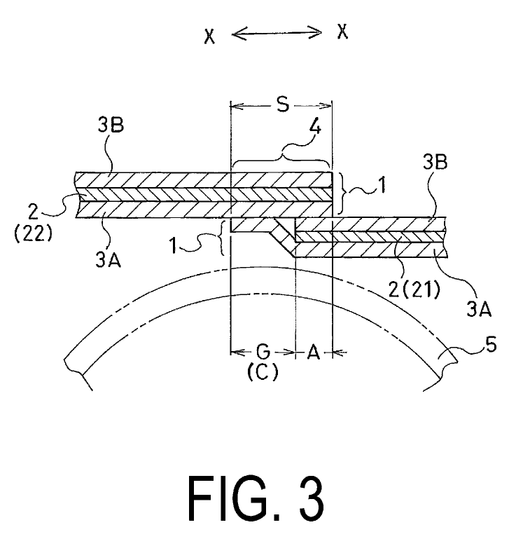

In the rubber sheet 3A on the tire cavity side, the portion formed longer than the adjacent film 2 is the portion of length indicated by reference sign Gin FIG. 1. In FIGS. 2 and 3 which illustrate other embodiments of the present technology, that portion of length G is as illustrated in each of the diagrams.

According to the present technology, due to the rubber sheet 3A on the tire cavity side of the innerliner member 1 disposed on the tire cavity side in the lap splice portion 4 being formed longer along the tire circumferential length than the adjacent film 2, the film end portion is not present at the position corresponding to the end face of the innerliner member 1, and as a result, the adhesion bonding force (tack) between the rubber sheets 3A and 3B is higher than the adhesion bonding force between the molding drum 5 and the rubber sheet 3A due to compression bonding during splicing, and the separation phenomenon between the rubber sheet 3A and the film 2 (the film 2 on the tire cavity side is indicated specially as reference sign 21, and the film 2 on the tire outer circumference side is indicated specially as reference sign 22 (FIGS. 1 to 3)) in a molded green tire can be suppressed.

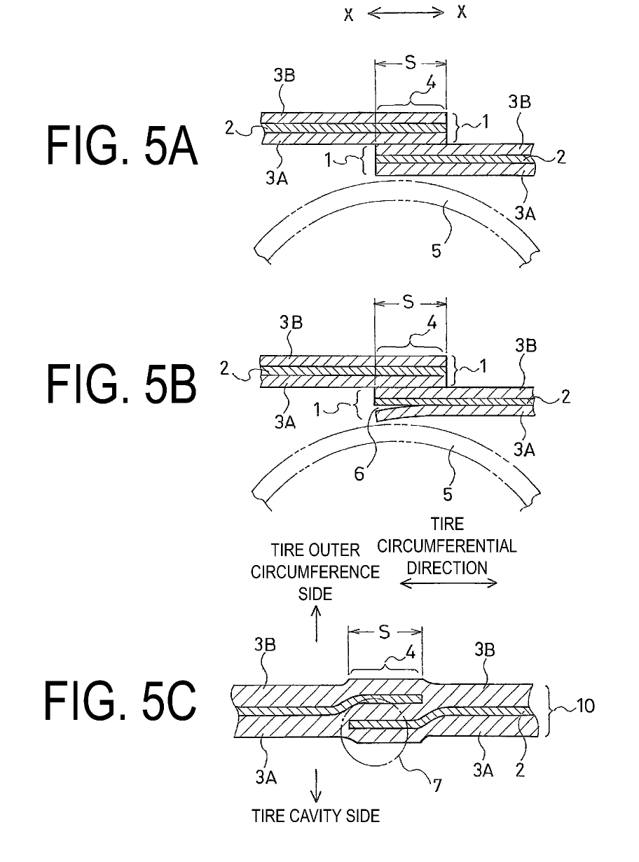

On the other hand, because the present technology has a structure in which rubber sheets 3A, 3B are layered on both sides of the film 2 having a main component of a thermoplastic resin or a thermoplastic elastomer composition containing a blend of a thermoplastic resin and an elastomer, a splice in which the splice surfaces are both rubber is possible, and a reliable rubber-to-rubber splice is possible similar to the conventional tire illustrated in FIG. 5 (FIGS. 1 to 3).

In the present technology, a length (G) for which the rubber sheet 3A on the tire cavity side of the innerliner member 1 disposed on the tire cavity side in the lap splice portion 4 is formed longer along the tire circumferential length than an adjacent film 21 is preferably not less than 3 mm and not greater than 25 mm. This is because when the length difference (G) is less than 3 mm, the area in which the rubber sheets 3A, 3B bond to each other during tire molding is small and the adhesion bonding force between the green tire and the molding drum 5 is large, resulting in the possibility of the separation phenomenon occurring. On the other hand, when it is longer than 25 mm, it leads to degradation of tire uniformity, which is undesirable.

A length (B) (FIGS. 1 and 2) for which the rubber sheet 3B on the tire outer circumference side of the innerliner member 1 disposed on the tire cavity side in the lap splice portion 4 is formed longer along the tire circumferential length than an adjacent film 2 (21) is preferably not less than 3. Due to being configured in this manner, bonding of the innerliner member 1 with itself can be performed more reliably.

Furthermore, the lap slice length (S) (FIG. 1, FIG. 2, FIG. 3) between the innerliner member 1 disposed on the tire outer circumference side and the innerliner member 1 disposed on the tire cavity side in the lap splice portion 4 is preferably not less than 3 mm and not greater than 25 mm. This is because when the lap splice length (S) is less than 3 mm, the overall adhesion bonding force at the splice portion is weak, and there is the possibility of the separation phenomenon occurring. On the other hand, when it is longer than 25 mm, it leads to degradation of tire uniformity, which is undesirable.

Additionally, the lap slice length (A) (FIG. 1, FIG. 2, FIG. 3) between a film 22 of the innerliner member 1 disposed on the tire outer circumference side and a film 21 of the innerliner member 1 disposed on the tire cavity side in the lap splice portion 4 is preferably not less than 0 mm, and more preferably not less than 3 mm. This is because when the splice length of the films 21, 22 is less than 0 mm, a portion where there is no film ends up being formed in the tire circumferential direction, and it is difficult to obtain the intrinsic good performance characteristics (air permeation preventive properties) of the film as an innerliner constituent member.

Furthermore, the rubber sheet 3B on the tire outer circumference side and the rubber sheet 3A on the tire cavity side of the innerliner member 1 disposed on the tire cavity side in the lap splice portion 4 have a length difference (C), and the rubber sheet 3A on the tire cavity side is preferably not less than 3 mm longer (FIG. 3). When configured in this manner, in particular when there is little or no difference in length between the film 21 and the rubber sheet 3B on the tire outer circumference side, the step in thickness in the lap splice portion 4 is small and tire uniformity is better.

Alternatively, the rubber sheet 3B on the tire outer circumference side and the rubber sheet 3A on the tire cavity side of the innerliner member 1 disposed on the tire cavity side in the lap splice portion 4 have a length difference (C), and the rubber sheet 3B on the tire outer circumference side is preferably not less than 3 mm longer (FIG. 2). When configured in this manner, the step in the lap splice portion 4 is small and the difference in thickness is gentler, the difference in rigidity is small, and the cracking is prevented, which are desirable.

In the present technology, the film 2 is a film having a main component of a thermoplastic resin, or a film having a main component of a thermoplastic elastomer composition containing a blend of a thermoplastic resin and an elastomer.

Examples of thermoplastic resin that can be used in the film 2 include a polyamide resin (e.g., nylon 6 (N6), nylon 66 (N66), nylon 46 (N46), nylon 11 (N11), nylon 12 (N12), nylon 610 (N610), nylon 612 (N612), a nylon 6/66 copolymer (N6/66), a nylon 6/66/610 copolymer (N6/66/610), nylon MXD6 (MXD6), nylon 6T, nylon 9T, a nylon 6/6T copolymer, a nylon 66/PP copolymer, a nylon 66/PPS copolymer) and an N-alkoxyalkyl compound thereof, e.g., a methoxymethyl compound of nylon 6, a methoxymethyl compound of a nylon 6/610 copolymer, or a methoxymethyl compound of nylon 612; a polyester resin (e.g., an aromatic polyester such as polybutylene terephthalate (PBT), polyethylene terephthalate (PET), polyethylene isophthalate (PEI), a PET/PEI copolymer, polyarylate (PAR), polybutylene naphthalate (PBN), a liquid crystal polyester, a polyoxyalkylene diimide acid/polybutylene terephthalate copolymer); a polynitrile resin (e.g., polyacrylonitrile (PAN), polymethacrylonitrile, an acrylonitrile/styrene copolymer (AS), a (meta)acrylonitrile/styrene copolymer, a (meta)acrylonitrile/styrene/butadiene copolymer), a polymethacrylate resin (e.g., polymethyl-methacrylate (PMMA), polyethyl-methacrylic acid), a polyvinyl resin (e.g., polyvinyl acetate, a polyvinyl alcohol (PVA), a vinyl alcohol/ethylene copolymer (EVOH), polyvinylidene chloride (PVDC), polyvinylchloride (PVC), a vinyl chloride/vinylidene chloride copolymer, a vinylidene chloride/methylacrylate copolymer, a vinylidene chloride/acrylonitrile copolymer (ETFE)), a cellulose resin (e.g., cellulose acetate, cellulose acetate butyrate), a fluoride resin (e.g., polyvinylidene difluoride (PVDF), polyvinyl fluoride (PVF), polychlorofluoroethylene (PCTFE), a tetrafluoroethylene/ethylene copolymer), and an imide resin (e.g., an aromatic polyimide (PI)).

Among these, polyester resin and polyamide resin are preferred due to their physical properties, processability, and ease of handling.

Further, for the resin and elastomer that constitute the blend (resin composition) that can be used to constitute the film 2, the above may be used as the resin (thermoplastic resin). Preferable examples of the elastomer constituting the blend (resin composition) include a diene rubber or a hydrogenate thereof (e.g., a natural rubber (NR), an isoprene rubber (IR), an epoxidized natural rubber, a styrene butadiene rubber (SBR), a butadiene rubber (BR, high cis-BR, and low cis-BR), a nitrile rubber (NBR), hydrogenated NBR, hydrogenated SBR), an olefin rubber (e.g., an ethylene propylene rubber (EPDM, EPM), a maleic acid modified ethylene propylene rubber (M-EPM), a butyl rubber (IIR), an isobutylene and aromatic vinyl or diene-based monomer copolymer, an acrylic rubber (ACM), an ionomer), a halogen-containing rubber (e.g., Br-IIR, CI-IIR, a brominated isobutylene-p-methylstyrene copolymer (BIMS), a chloroprene rubber (CR), a hydrin rubber (CHR), a chlorosulfonated polyethylene rubber (CSM), a chlorinated polyethylene rubber (CM), a chlorinated polyethylene rubber modified with maleic acid (M-CM)), a silicone rubber (e.g., a methyl vinyl silicone rubber, a dimethyl silicone rubber, a methylphenyl vinyl silicone rubber), a sulfur-containing rubber (e.g., a polysulfide rubber), a fluororubber (e.g., a vinylidene fluoride rubber, a vinyl ether rubber containing fluoride, a tetrafluoroethylene-propylene rubber, a silicon rubber containing fluoride, a phosphazene rubber containing fluoride), and a thermoplastic elastomer (e.g., a styrene elastomer, an olefin elastomer, an ester elastomer, a urethane elastomer, a polyamide elastomer).

In particular, it is preferable for at least 50 wt. % of the elastomer to be a halogenated butyl rubber, a brominated isobutylene-paramethyl-styrene copolymer rubber, or a maleic anhydride-modified ethylene a olefin copolymer rubber from the perspective of being able to increase the rubber volume ratio so as to soften and enhance the durability of the elastomer at both low and high temperatures.

In addition, it is preferable for at least 50 wt. % of the thermoplastic resin in the blend to be any one of nylon 11, nylon 12, nylon 6, nylon 6, nylon 66, a nylon 6/66 copolymer, a nylon 6/12 copolymer, a nylon 6/10 copolymer, a nylon 4/6 copolymer, a nylon 6/66/12 copolymer, aromatic nylon, or an ethylene/vinyl alcohol copolymer from the perspective of being able to obtain excellent durability.

Moreover, when the compatibility is different upon obtaining a blend by blending a combination of the previously specified thermoplastic resin and the previously specified elastomer, a suitable compatibility agent may be used as a third component to enable compatibilization of both the resin and the elastomer. By mixing the compatibility agent in the blend, interfacial tension between the thermoplastic resin or the elastomer is reduced, and as a result, the particle size of the elastomer that forms the dispersion phase becomes very small and thus the characteristics of both components may be realized effectively. In general, such a compatibility agent has a copolymer structure of both or either the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. While the type of compatibility agent may be selected according to the type of thermoplastic resin and elastomer to be blended, such a compatibility agent generally includes: a styrene/ethylene butylene block copolymer (SEBS) or a maleic acid modified compound thereof; an EPDM (ethylene-propylene-diene rubber), EPM (ethylene-propylene rubber), EPDM/styrene or EPDM/acrylonitrile graft copolymer or a maleic acid modified compound thereof; a styrene/maleic acid copolymer, or a reactive phenoxy, and the like. The compounded amount of such a compatibility agent is not particularly limited, but may preferably be from 0.5 to 10 parts by weight relative to 100 parts by weight of the polymer components (the total amount of the thermoplastic resin and the elastomer).

A composition ratio of the specified thermoplastic resin and the elastomer in the blend obtained by blending a thermoplastic resin with an elastomer is not particularly limited and may be determined as appropriate to establish a dispersed structure as a discontinuous phase of the elastomer in the matrix of the thermoplastic resin, and is preferably within a range of a weight ratio of from 90/10 to 30/70.

In the present technology, a compatibility agent or other polymers may be blended with the thermoplastic resin or the blend of a thermoplastic resin blended with an elastomer, within a range that does not harm the characteristics required for constituting the film 2, for example. The purposes of mixing such a polymer are to improve the compatibility between the thermoplastic resin and the elastomer, to improve the molding workability of the material, to improve the heat resistance, to reduce cost, and the like. Examples of the material used for the polymer include polyethylene (PE), polypropylene (PP), polystyrene (PS), acrylonitrile butadiene styrene (ABS), polystyrene-butadiene-styrene (SBS), and polycarbonate (PC).

Furthermore, a reinforcing agent such as a filler (calcium carbonate, titanium oxide, alumina, and the like), carbon black, or white carbon, a softening agent, a plasticizer, a processing aid, a pigment, a dye, or an anti-aging agent that are generally compounded with polymer compounds may be optionally compounded so long as the required characteristics as the film 2 are not hindered. The blend of a thermoplastic resin and an elastomer has a structure in which the elastomer is distributed as a discontinuous phase in the matrix of the thermoplastic resin. Due to having such a structure, moldability equal to that of a thermoplastic resin can be obtained.

Furthermore, the elastomer blended with the thermoplastic resin can be dynamically vulcanized when being mixed with the thermoplastic resin. A vulcanizing agent, a vulcanization aid, vulcanization conditions (temperature, time), and the like, for the dynamic vulcanization can be determined as appropriate in accordance with the composition of the elastomer to be added, and are not particularly limited.

By dynamically vulcanized the elastomer in the thermoplastic resin composition in this manner, a film that contains a vulcanized elastomer is obtained. Therefore, the film has resistance (elasticity) against deformation from the outside, which is preferable in that the effect of the present technology can be enhanced.

Generally available rubber vulcanizing agents (crosslinking agents) can be used as the vulcanizing agent. Specifically, as a sulfur-based vulcanizing agent, powdered sulfur, precipitated sulfur, highly dispersible sulfur, surface treated sulfur, insoluble sulfur, dimorpholine disulfide, alkylphenol disulfide, and the like can be used, and, for example, approximately from 0.5 to 4 phr (in the present specification, “phr” refers to parts by weight per 100 parts per weight of an elastomer component; similarly hereinafter) can be used.

Moreover, examples of an organic peroxide-based vulcanizing agent include benzoyl peroxide, t-butyl hydroperoxide, 2,4-dichlorobenzoyl peroxide, 2,5-dimethyl-2,5-di(t-butyl peroxy)hexane, 2,5-dimethylhexane-2,5-di(peroxyl benzoate), and the like. Such an organic peroxide-based vulcanizing agent can be used in an amount of, for example, around from 1 to 20 phr.

Furthermore, examples of a phenol resin-based vulcanizing agent include brominated alkylphenol resins and mixed crosslinking systems containing an alkyl phenol resin with a halogen donor such as tin chloride and chloroprene. Such a phenol resin-based vulcanizing agent can be used in an amount of, for example, approximately from 1 to 20 phr.

Examples of other vulcanizing agents include zinc oxide (about 5 phr), magnesium oxide (about 4 phr), litharge (from about 10 to 20 phr), p-quinone dioxime, p-dibenzoylquinone dioxime, tetrachloro-p-benzoquinone, poly-p-dinitrosobenzene (from about 2 to 10 phr), and methylenedianiline (from about 0.2 to 10 phr).

As necessary, a vulcanization accelerator may be added. For the vulcanization accelerator, generally available vulcanization accelerators such as aldehyde-ammonia-based, guanidine-based, thiazole-based, sulfenamide-based, thiuram-based, dithioic acid salt-based, and thiourea-based vulcanization accelerators can be used in an amount of, for example, from approximately 0.5 to 2 phr.

Here, the weight ratio of thermoplastic resin and elastomer in the blend is not particularly limited but is preferably set to from 10/90 to 80/20, and more preferably from 20/80 to 70/30, and is preferably adjusted so that the elastomer component in the thermoplastic resin matrix is dispersed homogeneously as a discontinuous phase.

Furthermore, as the rubber material that constitutes the rubber sheets 3A, 3B, diene rubbers such as natural rubber, isoprene rubber, epoxidized natural rubber, styrene-butadiene rubber, and hydrogenated styrene-butadiene rubber, or olefin rubbers such as ethylene-propylene rubber and maleic acid modified ethylene-propylene rubber may be advantageously used.

Furthermore, to increase adhesion between the film 2 and the adjacent rubber sheets 3A, 3B, they are preferably layered with an adhesive layer interposed therebetween. As the polymer that constitutes the adhesive layer, an ultra high molecular weight polyethylene having a molecular weight of not less than 1,000,000 and preferably not less than 3,000,000; acrylate copolymers such as ethylene-ethylacrylate copolymers, ethylene-methylacrylate resins, and ethylene-acrylic acid copolymers, and maleic anhydrate adducts thereof; polypropylene and maleic acid-modified products thereof; ethylene-propylene copolymers and maleic acid-modified products thereof; polybutadiene resins and maleic anhydrate-modified products thereof, styrene-butadiene-styrene copolymers; styrene-ethylene-butadiene-styrene copolymers; thermoplastic fluororesins; or thermoplastic polyester resins; and the like are preferably used.

In the present technology, the thickness of the film 2 is not particularly limited, but typically, a thickness of approximately from 0.002 to 0.3 mm is preferred. Furthermore, the thickness of each of the rubber sheets 3A, 3B is not particularly limited, but a thickness from 0.1 to 1.8 mm and preferably from 0.2 to 1.0 mm is practical. Here, when the rubber sheet thickness is less than 0.1 mm, the operation of layering on the film 2 is more difficult and it is more difficult to suppress degradation of the film 2 due to heat from the bladder during vulcanization. When it exceeds 1.8 mm, it causes tire weight to increase, which is undesirable.

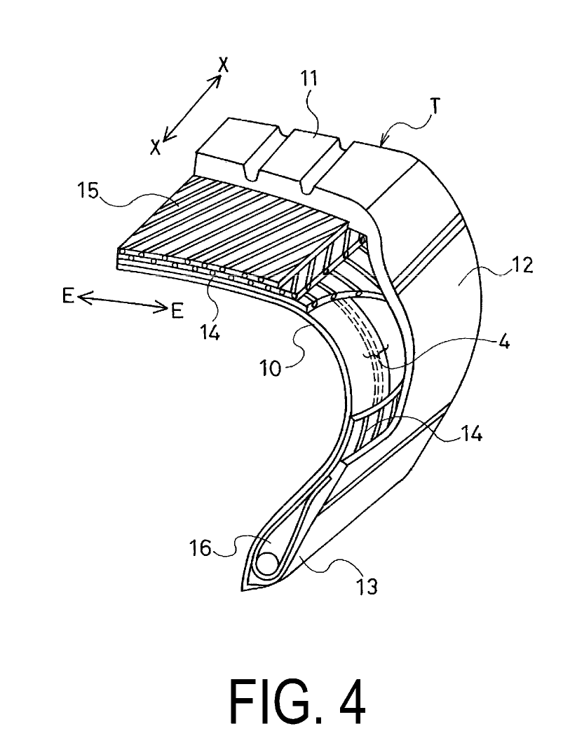

FIG. 4 is a partially fragmented perspective view illustrating an example of an embodiment of the pneumatic tire according to the present technology.

A pneumatic tire T is provided with a tread portion 11, sidewall portions 12, and bead portions 13, the sidewall portions 12 and the bead portions 13 being connected on the left and right of the tread portion 11. On the tire inner side of the pneumatic tire T, a carcass layer 14 that acts as a framework of the tire is provided so as to extend between the left and right bead portions 13, 13 in the tire width direction. Two belt layers 15 composed of steel cords are provided on the outer circumferential side of the carcass layer 14 corresponding to the tread portion 11. The arrow E indicates the tire width direction, and the arrow X indicates the tire circumferential direction. An innerliner layer 10 is disposed on an inner side of the carcass layer 14, and a lap splice portion 4 thereof is present extending in the tire width direction.

In the pneumatic tire according to the present technology, cracking, separation, and opening of the bond portion that conventionally tend to occur in the vicinity of the lap splice portion 4 on the tire inner circumferential surface during tire vulcanization molding and after the start of travel are suppressed, and productivity and durability are significantly improved.

### EXAMPLES

### Examples 1 to 5 and Comparative Example 1

The pneumatic tire of the present technology will be specifically described below through examples and the like.

Pneumatic tires were evaluated by the methods described below in regard to delamination resistance (separation resistance) in the green tire, delamination resistance (separation resistance) in the product tire, and tire uniformity.

As test tires, ten tires were manufactured for each of the examples (Examples 1 to 5) and comparative examples (Comparative Example 1) with a tire size of 195/65R15 91H. They were mounted on a JATMA (Japan Automobile Tyre Manufacturers Association, Inc.) standard rim 15×6J, and submitted to testing.

Comparative Example 1 had the conventional splice structure illustrated in FIG. 5A, and the tires of the examples of the present technology had the structures illustrated in FIGS. 1 to 3. The values of (S), (G), (B), (C), and (A) of each of the examples are shown in Table 1.

(S): Lap splice length in the circumferential direction of the innerliner member with itself (mm)

(G): Length for which the rubber sheet on the tire cavity side of the innerliner member disposed on the tire cavity side in the lap splice portion is formed longer along the tire circumferential length than an adjacent film (mm)

(A): Lap slice length between the film of the innerliner member disposed on the tire outer circumference side and the film of the innerliner member disposed on the tire cavity side in the lap splice portion (mm)

(B): Length for which the rubber sheet on the tire outer circumference side of the innerliner member disposed on the tire cavity side in the lap splice portion is formed longer along the tire circumferential length than an adjacent film (mm)

(C): Difference in length between the rubber sheet on the tire outer circumference side and the rubber sheet on the tire cavity side of the innerliner member disposed on the tire cavity side in the lap splice portion (mm)

The film was 0.1 mm thick, and the rubber sheets were 0.7 mm thick.

(a) Delamination resistance (separation resistance) in green tire:

In the completed green state, the tire inner surface of the splice portion of the innerliner was checked to ascertain the presence/absence of delamination. It was ascertained by visual observation.

(b) Delamination resistance (separation resistance) in product tire: Using a drum testing machine, the tire was ran for 80 hours at an internal tire pressure of 120 kPa, load of 7.24 kN, and speed of 81 km/h, and the tire inner surface of the splice portion of the innerliner was checked to ascertain the presence/absence of delamination. It was ascertained by visual observation.

(c) Tire uniformity test: RFV (maximum radial force deformation) was measured according to JASO C-607-87. It was evaluated by determining the average value of 10 samples (n). The results were expressed as index numbers, with the result of the conventional splice structure tire (Comparative Example 1) being defined as 100. A higher numeric value indicates a superior tire, and 5% was judged to be a significant difference.

The specifications of each of the above test tires are shown together with the evaluation results in Table 1.

As shown in Table 1, in the pneumatic tire according to the present technology, there is no occurrence of failures such as delamination or cracking in the vicinity of the lap splice portion, either during green tire molding, after vulcanization molding of the tire, or after the pneumatic tire starts to travel.

TABLE 1

| | Comparative | Example | Example | Example | Example | Example |
|---|---|---|---|---|---|---|
| | Example 1 | 1 | 2 | 3 | 4 | 5 |
| Illustrated | FIG. 5A | FIG. 1 | FIG. 3 | Not | FIG. 2 | Not |
| embodiment | | | | illustrated | | illustrated |
| (S) (mm) | Present | Present | Present | Present | Present | Present |
| | (10 mm) | (5 mm) | (5 mm) | (9 mm) | (9 mm) | (9 mm) |
| (G) (mm) | — | Present | Present | Present | Present | Present |
| | | (3 mm) | (3 mm) | (6 mm) | (3 mm) | (3 mm) |
| (A) (mm) | Present | Present | Present | Present | Present | Present |
| | (10 mm) | (2 mm) | (2 mm) | (3 mm) | (3 mm) | (6 mm) |
| (B) (mm) | — | Present | Absent | Present | Present | Present |
| | | (3 mm) | | (3 mm) | (6 mm) | (−3 mm) |
| (C) (mm) | — | Absent | Present | Present | Present | Present |
| | | | (3 mm) | (3 mm) | (3 mm) | (6 mm) |
| Presence/absence | Present | Absent | Absent | Absent | Absent | Absent |
| of delamination | | | | | | |
| (green tire) | | | | | | |
| Presence of | Present | Absent | Absent | Absent | Absent | Absent |
| delamination | | | | | | |
| (after tire travels) | | | | | | |
| Uniformity | 100 | 102 | 105 | 101 | 101 | 101 |

Notes:
(S): Lap splice length in the circumferential direction of the innerliner member with itself (mm)
(G): Length for which the rubber sheet on the tire cavity side of the innerliner member disposed on the tire cavity side in the lap splice portion is formed longer along the tire circumferential length than an adjacent film (mm)
(A): Lap slice length between the film of the innerliner member disposed on the tire outer circumference side and the film of the innerliner member disposed on the tire cavity side in the lap splice portion (mm)
(B): Length for which the rubber sheet on the tire outer circumference side of the innerliner member disposed on the tire cavity side in the lap splice portion is formed longer along the tire circumferential length than an adjacent film (mm)
(C): Difference in length between the rubber sheet on the tire outer circumference side and the rubber sheet on the tire cavity side of the innerliner member disposed on the tire cavity side in the lap splice portion (mm)

1. A pneumatic tire, comprising:
an innerliner member applied on a tire inner circumferential surface, the innerliner member being constituted from an at least three-layer structure comprising a film having a main component of a thermoplastic resin or a thermoplastic elastomer composition containing a blend of a thermoplastic resin and an elastomer, and rubber sheets layered on both sides of the film; and
a lap splice portion in which tire circumferential direction end portions of the film are overlapped with the rubber sheets inbetween; wherein
the rubber sheet on a tire cavity side of the innerliner member disposed on the tire cavity side in the lap splice portion is formed longer along the tire circumferential length than the film adjacent thereto.

2. The pneumatic tire according to claim 1, wherein a length for which the rubber sheet on the tire cavity side of the innerliner member disposed on the tire cavity side in the lap splice portion is formed longer along the tire circumferential length than the adjacent film is not less than 3 mm.

3. The pneumatic tire according to claim 1, wherein a length for which the rubber sheet on the tire outer circumference side of the innerliner member disposed on the tire cavity side in the lap splice portion is formed longer along the tire circumferential length than the adjacent film is not less than 3 mm.

4. The pneumatic tire according to claim 1, wherein a lap slice length between the innerliner member disposed on the tire outer circumference side and the innerliner member disposed on the tire cavity side in the lap splice portion is not less than 3 mm and not greater than 25 mm.

5. The pneumatic tire according to claim 1, wherein a lap slice length between a film of the innerliner member disposed on the tire outer circumference side and a film of the innerliner member disposed on the tire cavity side in the lap splice portion 4 is not less than 0 mm.

6. The pneumatic tire according to claim 1, wherein the rubber sheet on the tire outer circumference side and the rubber sheet on the tire cavity side of the innerliner member disposed on the tire cavity side in the lap splice portion have a length difference, and the rubber sheet on the tire cavity side is not less than 3 mm longer.

7. The pneumatic tire according to claim 1, wherein the rubber sheet on the tire outer circumference side and the rubber sheet on the tire cavity side of the innerliner member disposed on the tire cavity side in the lap splice portion have a length difference, and the rubber sheet on the tire outer circumference side is not less than 3 mm longer.

8. The pneumatic tire according to claim 3, wherein a lap slice length between the innerliner member disposed on the tire outer circumference side and the innerliner member disposed on the tire cavity side in the lap splice portion is not less than 3 mm and not greater than 25 mm.

9. The pneumatic tire according to claim 8, wherein a lap slice length between a film of the innerliner member disposed on the tire outer circumference side and a film of the innerliner member disposed on the tire cavity side in the lap splice portion is not less than 0 mm.

10. The pneumatic tire according to claim 9, wherein the rubber sheet on the tire outer circumference side and the rubber sheet on the tire cavity side of the innerliner member disposed on the tire cavity side in the lap splice portion have a length difference, and the rubber sheet on the tire cavity side is not less than 3 mm longer.

11. The pneumatic tire according to claim 9, wherein the rubber sheet on the tire outer circumference side and the rubber sheet on the tire cavity side of the innerliner member disposed on the tire cavity side in the lap splice portion have a length difference, and the rubber sheet on the tire outer circumference side is not less than 3 mm longer.
